(19) United States
(12) Patent Application Publication
(10) Pub. No.: US 2017/0078926 A1
(43) Pub. Date: Mar. 16, 2017

(54) RADIO ACCESS NETWORK FALLBACK

(71) Applicant: Telefonaktiebolaget LM Ericsson (publ), Stockholm (SE)

(72) Inventors: Jinyin Zhu, Shanghai (CN); Qi Xia, Shanghai (CN); Mikael Wass, Sätila (SE); Peter Ramle, Mölnlycke (SE); Lars-Bertil Olsson, Angered (SE)

(21) Appl. No.: 15/308,903

(22) PCT Filed: Jun. 25, 2014
(86) PCT No.: PCT/IB2014/062590

§ 371 Date: Nov. 4, 2016

(51) Int. Cl. H04W 36/00; H04W 36/32; H04W 60/04

(52) U.S. Cl. CPC H04W 36/0022; H04W 36/0033; H04W 60/04; H04W 36/32

(57) ABSTRACT

There is provided radio access network (RAN) fallback support indication of a wireless device. A mobility management node receives RAN fallback support indication parameters of the wireless device from a RAN node. The mobility management node sends the RAN fallback support indication parameters of the wireless device to at least one of a target core network node of the wireless device and a target RAN node of the wireless device.

### TECHNICAL FIELD

Embodiments presented herein relate to radio access network fallback support indication of a wireless device, and particularly to methods, a mobility management node, a radio access network node, computer programs, and a computer program product for radio access network fallback support indication of a wireless device.

### BACKGROUND

In communications networks, there may be a challenge to obtain good performance and capacity for a given communications protocol, its parameters and the physical environment in which the communications network is deployed.

For example, when a wireless device initiates a combined Attach or Tracking Area/Location Area (TA/LA) Update procedure towards a mobility management entity (MME) in order to be registered in the circuit-switched (CS) domain as well as in the Evolved Packet System (EPS) domain, the MME performs location update of the wireless device towards a mobile switching center (MSC) Server. Before performing the location update, the MME needs to select a public land mobile network (PLMN) and a radio access technology (RAT) of the CS domain and then derive the MSC to serve the wireless device.

In case multiple PLMNs or RATs are available for the CS domain, the MME performs selection of the PLMN and RAT for the CS domain based on the PLMN identity (ID) contained in the current tracking area identifier (TAI), in the old location area identifier (LAI) and operator selection policies for a preferred RAT for the CS domain.

When MME selects the PLMN and RAT of the CS domain, the MME does not take the radio capabilities of the wireless device into account. The result may be that the frequency bands of the selected PLMN and RAT is not compatible with the radio capabilities of the wireless device. In this case, when the wireless device later performs circuit-switched fallback (CSFB), the allocated LM, which serves the selected PLMN and RAT and is provided by the MME to the radio base station serving the wireless device, will not benefit the wireless device for cell selection in the CS domain. The wireless device thus has to perform cell reselection by itself and then perform the location update procedure before any CS service, such as voice call, can be performed. In the worst case, the wireless device will have to perform a re-registration procedure with a new MSC other than the current MSC associated with the MME. This may increase the latency of, for example, CS voice call setup time, or even worse the call may be dropped.

Hence, there is still a need for an improved RAN selection for a wireless device during fallback.

### SUMMARY

An object of embodiments herein is to provide improved RAN selection for a wireless device during fallback.

According to a first aspect there is presented a method for radio access network (RAN) fallback support indication of a wireless device. The method is performed by a mobility management node. The method comprises receiving RAN fallback support indication parameters of the wireless device from a RAN node. The method comprises sending the RAN fallback support indication parameters of the wireless device to at least one of a target core network node of the wireless device, a target RAN node of the wireless device.

Advantageously this enables efficient RAN selection of the wireless device during fallback.

The RAN fallback support indication may be a fallback support indication, for example supporting CSFB or similar, for the wireless device from E-UTRAN to at least one of GERAN and UTRAN.

Advantageously this improves the CSFB success rate and enables an improved CSFB experience.

The RAN fallback support indication parameters may comprise a list of PLMNs supported by the wireless device, a list of RATs supported by the wireless device, and/or a list of LAIs supported by the wireless device.

The core network node may be a mobility management node, and the RAN node may be an eNB.

According to a second aspect there is presented a mobility management node for RAN fallback support indication of a wireless device. The mobility management node comprises a processing unit. The processing unit is configured to receive RAN fallback support indication parameters of the wireless device from a RAN node. The processing unit is configured to send the RAN fallback support indication parameters of the wireless device to at least one of a target core network node of the wireless device and a target RAN node of the wireless device.

The mobility management node may be a mobility management entity (MME).

According to a third aspect there is presented a computer program for RAN fallback support indication of a wireless device, the computer program comprising computer program code which, when run on a processing unit of the mobility management node, causes the processing unit to perform a method according to the first aspect.

According to a fourth aspect there is presented a method for RAN fallback support indication of a wireless device. The method is performed by a RAN node. The method comprises acquiring a need to send RAN fallback support indication parameters of a wireless device to a mobility management node. The method comprises, in response thereto, sending the RAN fallback support indication parameters of the wireless device to the mobility management node.

According to a fifth aspect there is presented a RAN node for RAN fallback support indication of a wireless device. The RAN node comprises a processing unit. The processing unit is configured to acquire a need to send RAN fallback support indication parameters of a wireless device to a mobility management node. The processing unit is configured to, in response thereto, send the RAN fallback support indication parameters of the wireless device to the mobility management node.

The RAN node may be an evolved Node B (eNB).

According to a sixth aspect there is presented a computer program for RAN fallback support indication of a wireless device, the computer program comprising computer program code which, when run on a processing unit of the RAN node, causes the processing unit to perform a method according to the fourth aspect.

According to a seventh aspect there is presented a computer program product comprising a computer program according to at least one of the third aspect ad the sixth aspect and a computer readable means on which the computer program is stored.

It is to be noted that any feature of the first, second, third, fourth, fifth, sixth and seventh aspects may be applied to any other aspect, wherever appropriate. Likewise, any advantage of the first aspect may equally apply to the second, third, fourth, fifth, sixth, and/or seventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1a, 1b, and 1c are schematic diagrams illustrating communications networks according to embodiments;

FIG. 2a is a schematic diagram showing functional units of a mobility management node according to an embodiment;

FIG. 2b is a schematic diagram showing functional modules of a mobility management node according to an embodiment;

FIG. 3a is a schematic diagram showing functional units of a RAN node according to an embodiment;

FIG. 3b is a schematic diagram showing functional modules of a RAN node according to an embodiment;

FIG. 4 shows one example of a computer program product comprising computer readable means according to an embodiment;

FIGS. 5, 6, 7, and 8 are flowcharts of methods according to embodiments; and

FIGS. 9, 10, and 11 are signalling diagrams according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

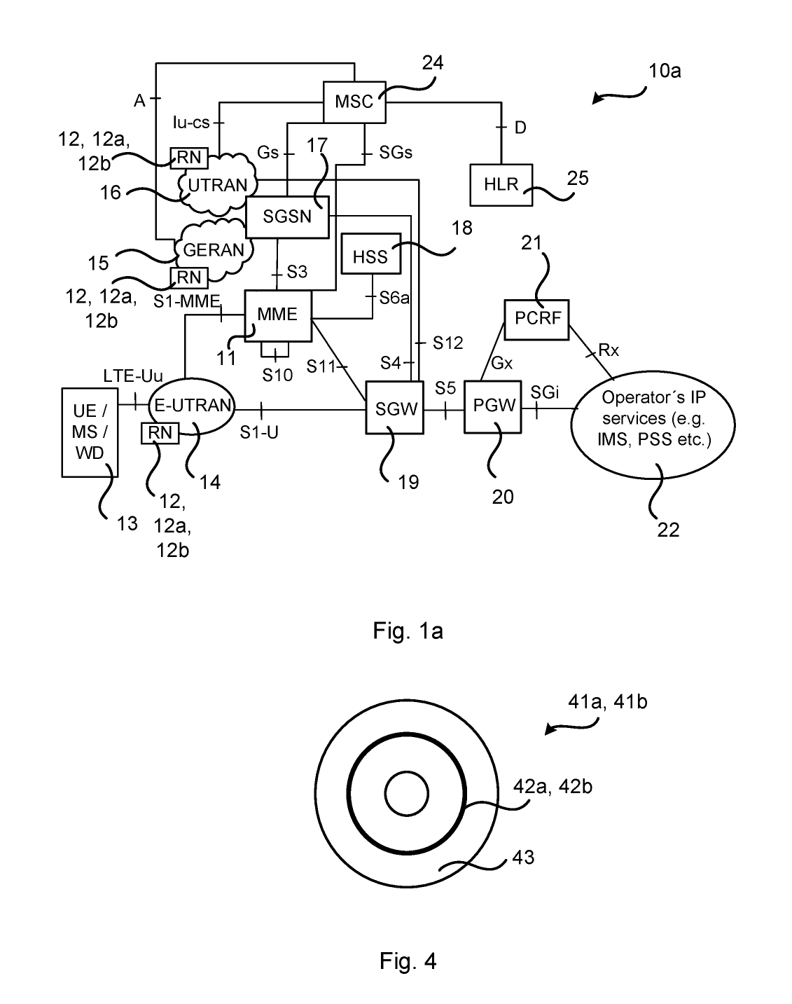

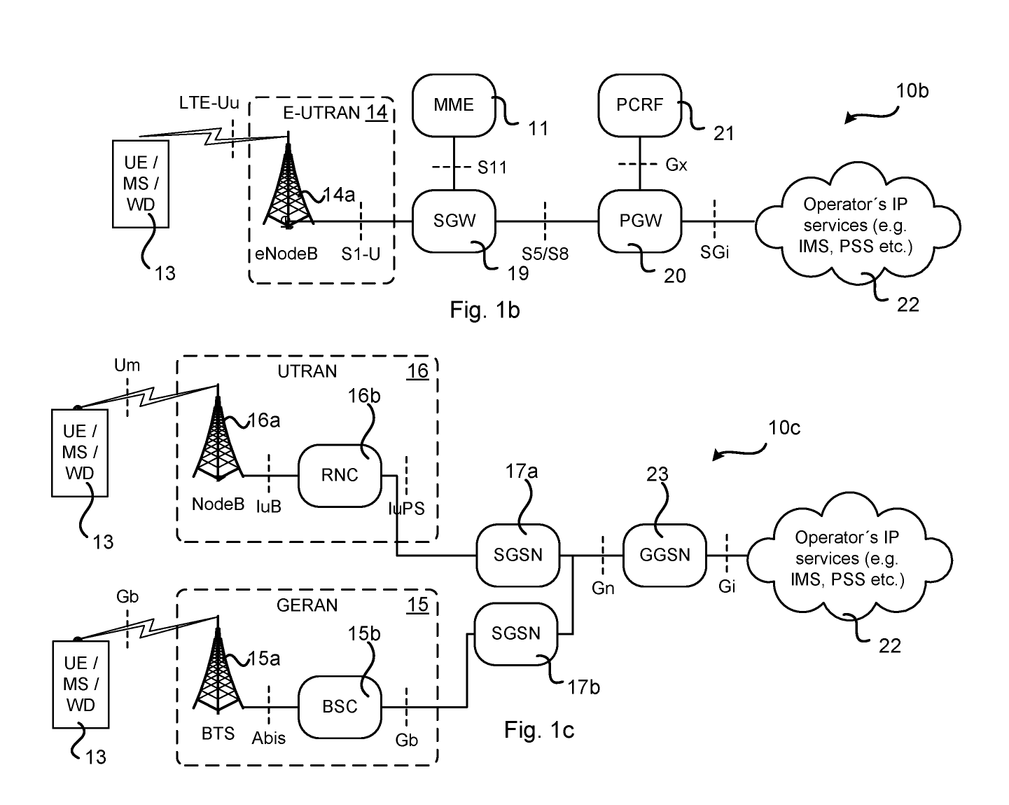

Collective reference is made to FIG. 1a, FIG. 1b, and FIG. 1c showing nodes and entities, as well as the interfaces operatively connecting the nodes and entities, of exemplifying communications networks 10a, 10b, and 10c.

FIG. 1a shows a schematic overview of an exemplifying communications network boa. The communications network boa is a so-called Long Term Evolution (LTE) based communications system. It should be pointed out that the terms “LTE” and “LTE based” system is here used to comprise both present and future LTE based systems, such as, for example, LTE advance systems. It should be appreciated that although FIG. 1a shows a communications network boa in the form of a LTE based system, the example embodiments herein may also be utilized in connection with other communications networks comprising nodes and functions that correspond to the nodes and functions of the system in FIG. 1a. The UTRAN 16, the GERAN 15 and the E-UTRAN 14 comprise Radio Access Network (RAN) nodes (RN) 12 operating as radio base stations for the wireless device 13. GERAN is short for GSM EDGE RAN, where GSM is short for Global System for Mobile communications, EDGE is short for Enhanced Data Rates for GSM Evolution, and RAN is short for Radio Access Network. UTRAN is short for UMTS Terrestrial Radio Access Network, where UMTS is short for Universal Mobile Telecommunications System. The RAN nodes 12 may act as a source RAN node 12a or as a target RAN node 12b for the wireless device 13.

FIG. 1b shows another schematic illustration of an exemplifying communications network 10b in the form of an LTE architecture. As can be seen, the communications network 10b comprises a RAN node 12, or base station, in the form of an evolved Node B (eNB) 14a, operatively connected to a Serving Gateway (SGW) 19, in turn operatively connected to a mobility management node 11 in the form of a Mobility Management Entity (MME) and to a PDN Gateway (PGW) 20, which in turn is operatively connected to a Policy and Charging Rules Function (PCRF) 21.

The eNodeB is a radio access node that interfaces with a wireless device 13 (to be elaborated in some detail below), also called a radio terminal or a mobile station (MS), and is denoted User Equipment (UE) in LTE. The eNodeBs of the system forms the radio access network E-UTRAN 14 for LTE. The SGW 19 routes and forwards user data packets, whilst also acting as the mobility anchor for the user plane during inter-eNB handovers and as the anchor for mobility between LTE and other 3GPP technologies (terminating S4 interface and relaying the traffic between 2G/3G systems and PGW 20). For idle state wireless devices 13, the SGW 19 terminates the downlink data path and triggers paging when downlink data arrives for the wireless device 13. It manages and stores wireless device contexts, e.g. parameters of the Internet Protocol (IP) bearer service, network internal routing information. It also performs replication of the user traffic in case of lawful interception.

The MME 11 is responsible for idle mode wireless device tracking and paging procedure including retransmissions. It is involved in the bearer activation/deactivation process and is also responsible for choosing the SGW 19 for a wireless device 13 at the initial attach and at time of intra-LTE handover involving Core Network (CN) node relocation. It is responsible for authenticating the user (by interacting with the Home Subscriber Server (HSS) 18, see FIG. 1a). The Non-Access Stratum (NAS) signaling terminates at the MME 11 and it is also responsible for generation and allocation of temporary identities to wireless devices 13. It checks the authorization of the wireless device 13 to camp on the service provider's Public Land Mobile Network (PLMN) and enforces roaming restrictions on the wireless device 13. The MME 11 is the termination point in the network for ciphering/integrity protection for NAS signaling and handles the security key management. Lawful interception of signaling is also supported by the MME 11. The MME 11 also provides the control plane function for mobility between LTE and 2G/3G access networks with the S3 interface terminating at the MME 11 from the SGSN 17. The MME 11 also terminates the S6a interface towards the home HSS 18 for roaming wireless devices 13.

The PGW 20 provides connectivity to the wireless device 13 to external packet data networks 22 by being the point of exit and entry of traffic for the wireless device 13. A wireless device 13 may have simultaneous connectivity with more than one PGW 20 for accessing multiple PDNs. The PGW 20 performs policy enforcement, packet filtering for each user, charging support, lawful Interception and packet screening. Another role of the PGW 20 is to act as the anchor for mobility between 3GPP and non-3GPP technologies such as WiMAX and 3GPP2 (CDMA 1× and EvDO).

The PCRF 21 determines policy rules in real-time with respect to the radio terminals of the system. This may e.g. include aggregating information in real-time to and from the core network and operational support systems etc. of the system so as to support the creation of rules and/or automatically making policy decisions for wireless devices 13 currently active in the communications network based on such rules or similar. The PCRF 21 provides the PGW 20 with such rules and/or policies or similar to be used by the acting PGW 20 as a Policy and Charging Enforcement Function (PCEF).

FIG. 1c shows another schematic illustration of an exemplifying communications network 10c in the form of a GPRS architecture 10c. As can be seen, the communications network 10c comprises a Gateway GPRS Support Node (GGSN) 23 connected to a first Serving GPRS Support Node (SGSN) 17a and a second SGSN 17b. In turn, the first SGSN 17a is connected to a Radio Network Controller (RNC) 16b that is operatively connected to a RAN node 12 in the form of a NodeB 16a, whereas the second SGSN 17b is operatively connected to a Base Station Controller (BSC) 15b that is connected to a RAN node 12 in the form of a Base Transceiver Station (BTS) 15a.

The GGSN 23 is responsible for the interworking between the GPRS network 10c and external packet data networks 22 providing operator's IP services, such as the Internet and X.25 networks. The GGSN 23 is the anchor point that enables the mobility of the wireless devices 13 in the GPRS/UMTS networks and it may be seen as the GPRS equivalent to the Home Agent in Mobile IP. It maintains routing necessary to tunnel the Protocol Data Units (PDUs) to the SGSN 17a, 17b that services a particular wireless device 13. The GGSN 23 converts the GPRS packets coming from the SGSN 17a, 17b into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN 17a, 17b. The GGSN 23 is responsible for IP address assignment and is the default router for the connected wireless devices 13. The GGSN 23 also performs authentication and charging functions. Other functions include subscriber screening, IP Pool management and address mapping, QoS and PDP context enforcement.

The SGSN 17a, 17b is responsible for the delivery of data packets from and to the wireless devices 13 within its geographical service area. Its tasks include packet routing and transfer, mobility management (attach/detach and location management), logical link management, and authentication and charging functions. The location register of the SGSN 17a, 17b stores location information (e.g., current cell, current Visitor Location Register (VLR)) and user profiles (e.g., International Mobile Station Identity (IMSI), address(es) used in the packet data network) of all GPRS users registered with this SGSN 17a, 17b.

The RNC 16b is a node in the UMTS radio access network (UTRAN) 16 and is responsible for controlling the NodeBs 16a that are operatively connected to it. The RNC 16b carries out radio resource management, some of the mobility management functions and is the point where encryption is done before user data is sent to and from the wireless device 13. The RNC 16b is operatively connected to a Circuit Switched Core Network through Media Gateway (MGW) and to the SGSN 17a in the Packet Switched Core Network.

The BSC 15b is a node in the GSM Radio Access Network (GERAN) 15 and is responsible for controlling the BTSs 15a that are connected to it. The BSC 15b carries out radio resource management and some of the mobility management functions.

The mobile switching centre 24 (commonly abbreviated as MSC Server or MSS) is a GSM core network element which controls the network switching subsystem elements.

The home location register (HLR) 25 is a central database that contains details of each wireless device subscriber that is authorized to use the GSM core network. There can be several logical, and physical, HLRs per public land mobile network (PLMN), though one international mobile subscriber identity (IMSI)/MSISDN pair can be associated with only one logical HLR (which can span several physical nodes) at a time.

As can be seen in FIGS. 1b and 1c, there are wireless devices 13 that communicate with the eNodeB 14a and/or the RNC 16b via a NodeB 16a and/or the BSC 15b via a BTS 15a using an air interface such as LTE-Uu, Um and Gb interface respectively. This makes it possible for the wireless devices 13 to access resources provided by the core network of the systems respectively. A skilled person having the benefit of this disclosure realizes that vast number of well known wireless devices 13 can be used in the various embodiments of the present disclosure. The wireless devices 13 may e.g. be a cell phone device or similar, e.g. such as a Mobile Station (MS) or a User Equipment (UE) or similar, e.g. defined by the standards provided by the 3GPP. Thus, the wireless device 13 needs no detailed description as such. However, it should be emphasized that the wireless devices 13 may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the wireless devices 13 may even be embedded in and/or attached to various semi-stationary devices, e.g. domestic appliances or similar, or consumer electronics such as printers or similar having a semi-stationary mobility character.

According to state of the art, when the MME 11 selects the PLMN and RAT for the circuit switched domain for the wireless device 13 during a combined.

Attach or a combined TA/LA Update procedure, the radio capabilities of the wireless device 13 to support the PLMNs and RATs is currently not considered. This may result in that the frequency band of the selected PLMN and RAT does not match the radio capabilities of the wireless device 13. In this case, when the wireless device 13 later performs CSFB, the wireless device 13 has to perform cell selection to search for a cell which it can access. After the cell is selected, the wireless device 13 has to perform a LA procedure before any CS services, such as a CS call, can be performed. In the worst case, the wireless device 13 will have to perform a re-registration procedure to a new MSC other than the current MSC associated with the MME. This may increase the latency of CS call setup time and thus impact the CSFB experience.

According to at least some of the embodiments presented herein, before the PLMN and the RAT of the CS domain are selected, if for any PLMN and RAT the MME has no knowledge about whether it matches the radio capabilities of the wireless device 13, the MME requests the RAN node to provide a list of PLMNs and RATs of the CS domain as supported by the wireless device 13. Particularly, the embodiments disclosed herein particularly relate to RAN fallback support indication of a wireless device 13. In order to obtain RAN fallback support indication of a wireless device 13 there is provided a mobility management node, a method performed by the mobility management node, a computer program comprising code, for example in the form of a computer program product, that when run on a processing unit of the mobility management node, causes the mobility management node to perform the method. In order to obtain RAN fallback support indication of a wireless device 13 there is further provided a RAN node, a method performed by the RAN node, a computer program comprising code, for example in the form of a computer program product, that when run on a processing unit of the RAN node, causes the RAN node to perform the method.

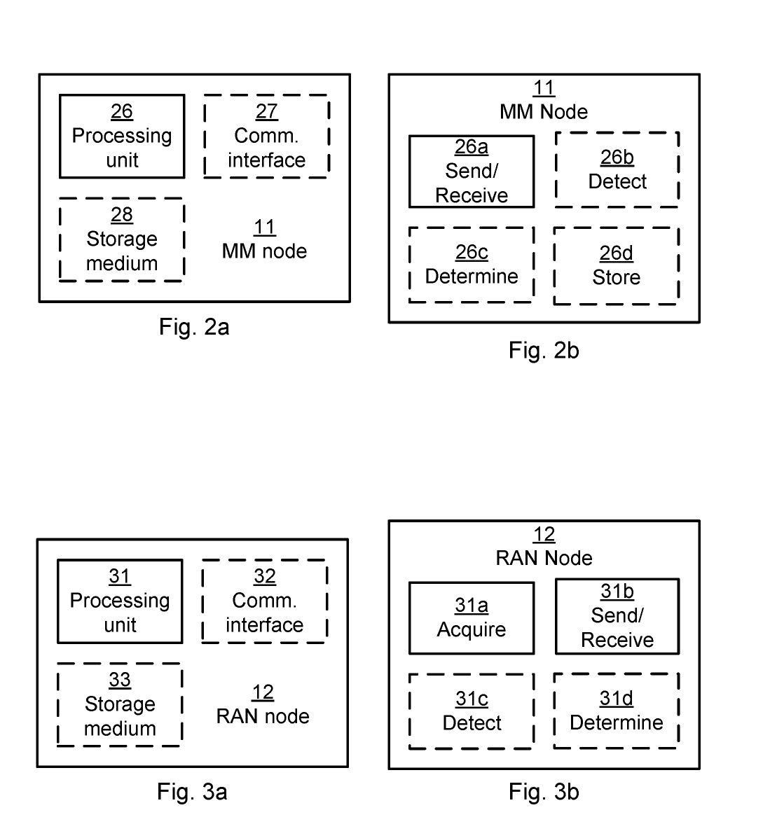

FIG. 2a schematically illustrates, in terms of a number of functional units, the components of a mobility management node 11 according to an embodiment. A processing unit 26 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41a (as in FIG. 4), e.g. in the form of a storage medium 28. Thus the processing unit 26 is thereby arranged to execute methods as herein disclosed. The storage medium 28 may also comprise persistent storage, which, for example, can be any single one or combination of magnetic memory, optical memory, solid state memory or even remotely mounted memory. The mobility management node 11 may further comprise a communications interface 27 for communications with other nodes and entities in the communications networks 10a, 10b, 10c. As such the communications interface 27 may comprise one or more transmitters and receivers, comprising analogue and digital components and a suitable number of ports. The processing unit 26 controls the general operation of the mobility management node 11 e.g. by sending data and control signals to the communications interface 27 and the storage medium 28, by receiving data and reports from the communications interface 27, and by retrieving data and instructions from the storage medium 28. Other components, as well as the related functionality, of the mobility management node 11 are omitted in order not to obscure the concepts presented herein. The mobility management node 11 may be a mobility management entity.

FIG. 2b schematically illustrates, in terms of a number of functional modules, the components of a mobility management node 11 according to an embodiment. The mobility management node 11 of FIG. 2b comprises a send and/or receive module 26a. The mobility management node 11 of FIG. 2b may further comprises a number of optional functional modules, such as any of a detect module 26b, a determine module 26c, and a store module 26d. The functionality of each functional module 26a-d will be further disclosed below in the context of which the functional modules 26a-d may be used. In general terms, each functional module 26a-d may be implemented in hardware or in software. Preferably, one or more or all functional modules 26a-d may be implemented by the processing unit 26, possibly in cooperation with functional units 27 and/or 28. The processing unit 26 may thus be arranged to from the storage medium 28 fetch instructions as provided by a functional module 26a-d and to execute these instructions, thereby performing any steps as will be disclosed hereinafter.

FIG. 3a schematically illustrates, in terms of a number of functional units, the components of a RAN node 12 according to an embodiment. A processing unit 31 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 41b (as in FIG. 4), e.g. in the form of a storage medium 43. Thus the processing unit 31 is thereby arranged to execute methods as herein disclosed. The storage medium 33 may also comprise persistent storage, which, for example, can be any single one or combination of magnetic memory, optical memory, solid state memory or even remotely mounted memory. The RAN node 12 may further comprise a communications interface 32 for communications with other nodes and entities in the communications networks 10a, 10b, 10c. As such the communications interface 32 may comprise one or more transmitters and receivers, comprising analogue and digital components and a suitable number of antennas for radio communications and a suitable number of ports for wired communications. The processing unit 31 controls the general operation of the RAN node 12 e.g. by sending data and control signals to the communications interface 32 and the storage medium 33, by receiving data and reports from the communications interface 32, and by retrieving data and instructions from the storage medium 33. Other components, as well as the related functionality, of the RAN node 12 are omitted in order not to obscure the concepts presented herein. The RAN node 12 may be an eNB 14a as in FIG. 1b, a NodeB 16a, a RNC 16b, a BTS 15a, or a BSC 15b as in FIG. 1c.

FIG. 3b schematically illustrates, in terms of a number of functional modules, the components of a RAN node 12 according to an embodiment. The RAN node 12 of FIG. 3b comprises a number of functional modules; an acquire module and a send and/or receive module 31b. The RAN node 12 of FIG. 3b may further comprises a number of optional functional modules, such as any of a detect module 31c and a determine module 31d. The functionality of each functional module 31a-d will be further disclosed below in the context of which the functional modules 31a-d may be used. In general terms, each functional module 31a-d may be implemented in hardware or in software. Preferably, one or more or all functional modules 31a-d may be implemented by the processing unit 26, possibly in cooperation with functional units 32 and/or 33. The processing unit 31 may thus be arranged to from the storage medium 33 fetch instructions as provided by a functional module 31a-d and to execute these instructions, thereby performing any steps as will be disclosed hereinafter.

FIG. 4 shows one example of a computer program product 41a, 41b comprising computer readable means 43. On this computer readable means 43, a computer program 42a can be stored, which computer program 42a can cause the processing unit 26 and thereto operatively coupled entities and devices, such as the communications interface 27 and the storage medium 28, to execute methods according to embodiments described herein. The computer program 42a and/or computer program product 41a may thus provide means for performing any steps as herein disclosed. On this computer readable means 43, a computer program 42b can be stored, which computer program 42b can cause the processing unit 31 and thereto operatively coupled entities and devices, such as the communications interface 32 and the storage medium 33, to execute methods according to embodiments described herein. The computer program 42b and/or computer program product 41b may thus provide means for performing any steps as herein disclosed.

In the example of FIG. 4, the computer program product 41a, 41b is illustrated as an optical disc, such as a CD (compact disc) or a DVD (digital versatile disc) or a Blu-Ray disc. The computer program product 41a, 41b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while each computer program 42a, 42b is here schematically shown as a track on the depicted optical disk, the computer program 42a, 42b can be stored in any way which is suitable for the computer program product 41a, 41b.

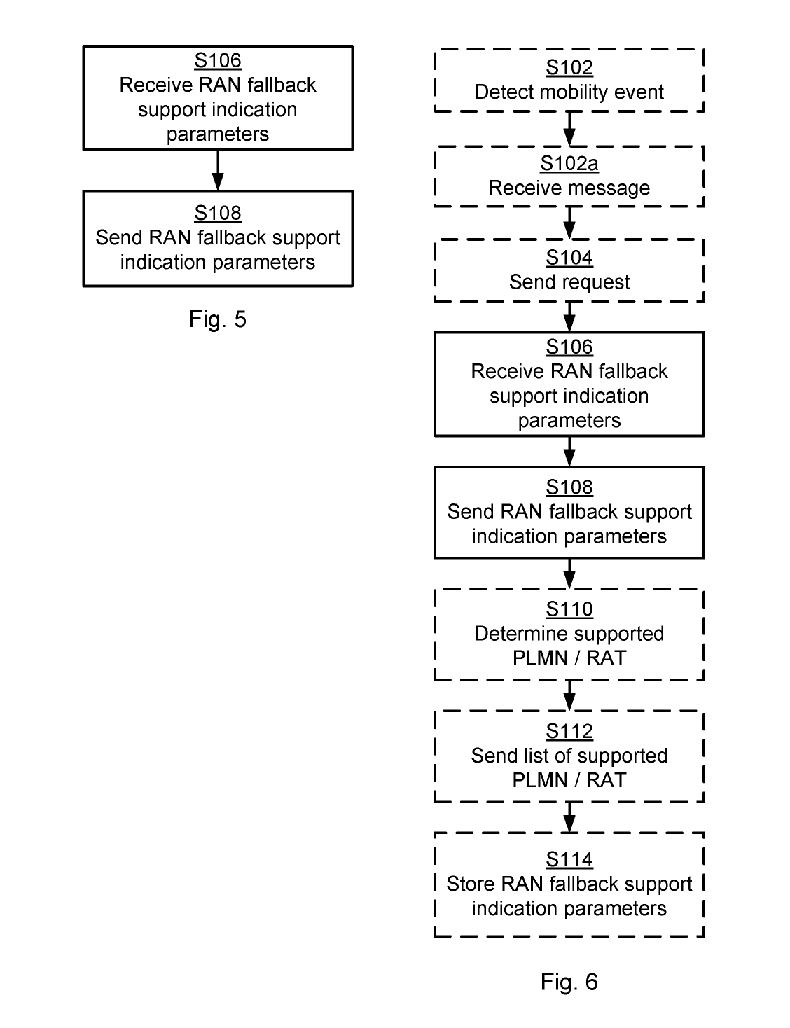

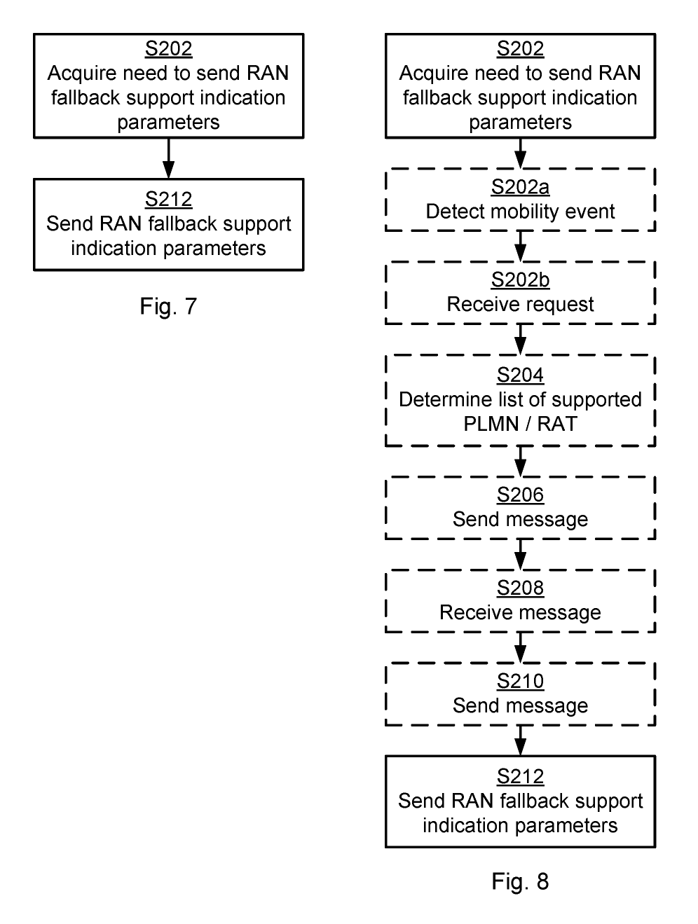

FIGS. 5 and 6 are flow chart illustrating embodiments of methods for RAN fallback support indication of a wireless device 13 as performed by the mobility management node 11. FIGS. 7 and 8 are flow chart illustrating embodiments of methods for RAN fallback support indication of a wireless device 13 as performed by the RAN node 12. The methods are advantageously provided as computer programs 42a, 42b.

Reference is now made to FIG. 5 illustrating a method for RAN fallback support indication of a wireless device 13 as performed by the mobility management node 11 according to an embodiment.

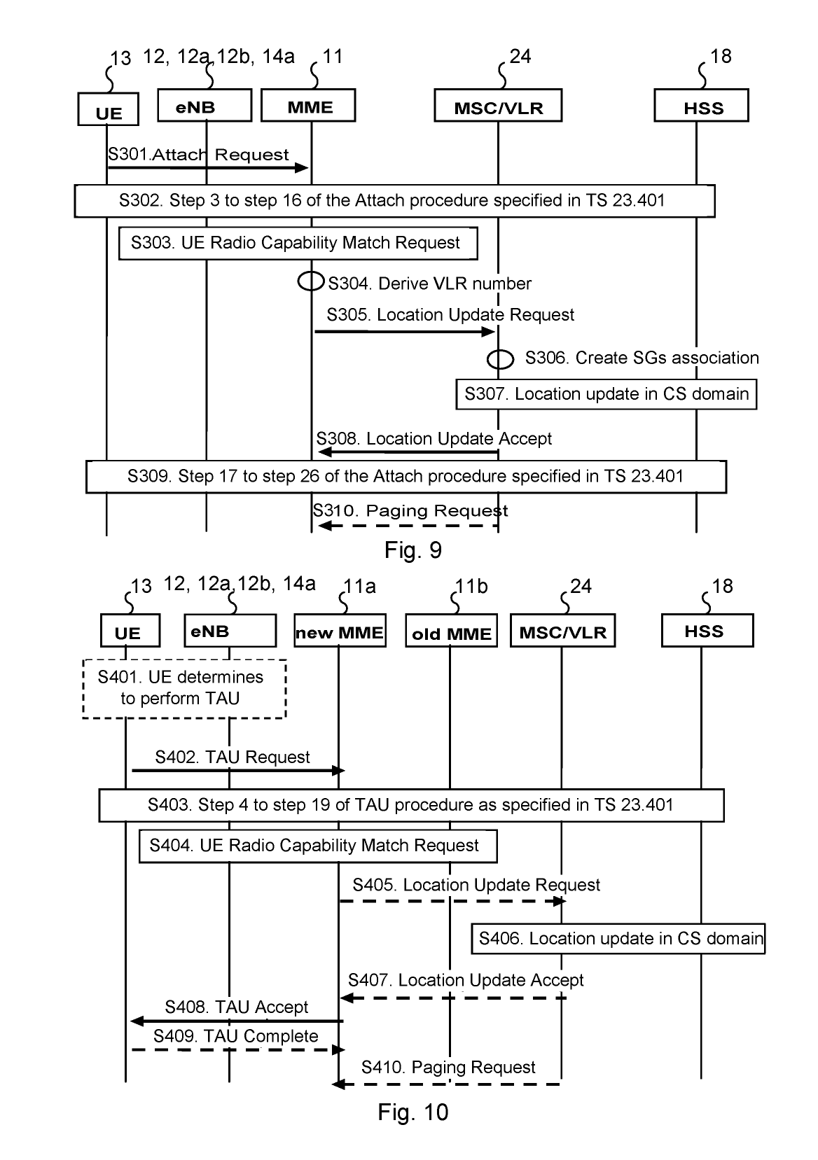

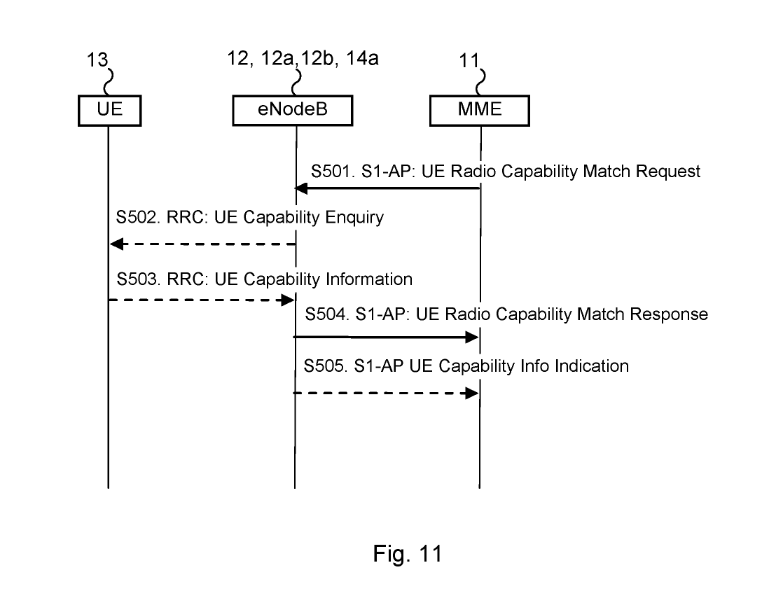

S106. The mobility management node 11 receives RAN fallback support indication parameters of the wireless device 13 from a RAN node 12 (e.g. as in S301 or S303 of FIG. 9, as in S403 or S404 in FIG. 10, or as in S504 or S505 of FIG. 11). The processing unit 26 of the mobility management node 11 may be configured to perform step S106 by executing functionality of the send and/or receive module 26a. The computer program 42a and/or computer program product 41a may thus provide means for this step.

S108. The mobility management node 11 (see e.g. the old MME in FIG. 10) sends the RAN fallback support indication parameters of the wireless device 13 to at least one of a target core network node (see e.g. the new MME 11b in FIG. 10) of the wireless device 13 and a target RAN node 12b of the wireless device 13 (e.g. as in S303 of FIG. 9, or as in S404 of FIG. 10). The processing unit 26 of the mobility management node 11 may be configured to perform step S108 by executing functionality of the send and/or receive module 26a.

The computer program 42a and/or computer program product 41a may thus provide means for this step

With reference to FIGS. 1a, 9, 10, and 11, the RAN node 12b acts as the target RAN node. With reference to FIGS. 1a, 9, 10, and 11, the MSC/VLE node 11b, see step 305 in FIG. 9, acts as the target core network node 11b. Thus, the target node may be either a radio access node such as an eNB or similar or a core network node such as a MSC node and/or VLE node or a combined MSC/VLR node.

Embodiments relating to further details of RAN fallback support indication of a wireless device 13 will now be disclosed.

The RAN fallback support indication may be a fallback support indication of the wireless device 13 from E-UTRAN to at least one of GERAN and UTRAN. The fallback support indication may be for CSFB or similar. More generally, the fallback support indication may be for any service (circuit switched or packet switched) supported by GERAN or UTRAN.

Reference is now made to FIG. 6 illustrating methods for RAN fallback support indication of a wireless device 13 as performed by the mobility management node 11 according to further embodiments.

The mobility management node 11 may request RAN fallback support indication parameters from a RAN node, as in optional steps S102 and S104.

S102. The mobility management node 11 may detect a mobility event of the wireless device 13, and in response thereto perform step S104. The processing unit 26 of the mobility management node 11 may be configured to perform step S102 by executing functionality of the detect module 26b. The computer program 42a and/or computer program product 41a may thus provide means for this step.

S104. The mobility management node 11 may send a request for the RAN fallback support indication parameters to the RAN node 12, e.g. such as a UE Radio Capability Match Request message or similar (e.g. as in S501 of FIG. 11). The processing unit 26 of the mobility management node 11 may be configured to perform step S104 by executing functionality of the send and/or receive module 26a. The computer program 42a and/or computer program product 41a may thus provide means for this step.

The request in S104 may be sent using a S1-AP message. The S1-AP message may be a UE Radio Capability Match Request message. The mobility event may relate to at least one of a combined Attach event and a combined TA/LA update.

There may be different ways for the mobility management node 11 to detect a mobility event in step S102. For example, detecting the mobility event may involve performing step S102a.

S102a. The mobility management node 11 may detect the mobility event of the wireless device 13 by receiving a request such as an attach request (e.g. as in S301 of FIG. 9) or similar from the wireless device 13, or by receiving a message from the RAN node 12, e.g. such as a UE Radio Capability Match Response message (e.g. as in S504 of FIG. 11) or similar from the RAN node 12 or a UE Capability Info Indication message or similar (e.g. as in S505 of FIG. 11). The processing unit 26 of the mobility management node 11 may be configured to perform step S102a by executing functionality of the detect module 26b. The computer program 42a and/or computer program product 41a may thus provide means for this step.

Different kind of information may be comprised in, and extractable from, the RAN fallback support indication parameters. Examples include, but are not limited to, identification of PLMNs and/or RATs or similar that is/are supported by the wireless device 13.

S110. The mobility management node 11 may determine at least one of a PLMN and a RAT or similar supported by the wireless device 13 from the RAN fallback support indication parameters (e.g. as in S304 of FIG. 9, as in S405 of FIG. 10, or as in S504 of FIG. 11). The processing unit 26 of the mobility management node 11 may be configured to perform step S110 by executing functionality of the determine module 26c. The computer program 42a and/or computer program product 41a may thus provide means for this step.

For example, the RAN fallback support indication parameter may comprise at least one of a list of PLMNs supported by the wireless device 13, a list of RATs supported by the wireless device 13, and a list of LAIs supported by the wireless device 13. The list may be sent to the target core network node and/or the target RAN node 12b, as in step S112.

S112. The mobility management node 11 may send at least one of the list of PLMNs supported by the wireless device 13 and the list of RATs supported by the wireless device 13 to at least one of the target core network node of the wireless device 13 and the target RAN node of the wireless device 13. The processing unit 26 of the mobility management node 11 may be configured to perform step S112 by executing functionality of the send and/or receive module 26a. The computer program 42a and/or computer program product 41a may thus provide means for this step

The at least one the list of PLMNs supported by the wireless device 13 and the list of RATs supported by the wireless device 13 may be sent using a S1-AP message or a GTPv2 message. The S1-AP message may be an Initial UE Context Setup message, a Path Switch Acknowledge message, or a Handover Request message. The GTPv2 message may be a Context Response message or a Forward Relocation Request message.

The list may be stored by the mobility management node 11, as in step S114.

S114. The mobility management node 11 may store the RAN fallback support indication parameters (e.g. as in S303 of FIG. 9, as in S304 of FIG. 10, or as in S504 of FIG. 11). The processing unit 26 of the mobility management node 11 may be configured to perform step S114 by executing functionality of the store module 26d. The computer program 42a and/or computer program product 41a may thus provide means for this step.

The RAN fallback support indication parameters may be stored at least until a further mobility event of the wireless device 13 is detected.

Reference is now made to FIG. 7 illustrating a method for RAN fallback support indication of a wireless device 13 as performed by the RAN node 12 according to an embodiment.

S202. The RAN node 12 acquires a need to send RAN fallback support indication parameters of a wireless device 13 to a mobility management node (e.g. as in S301 or S303 of FIG. 9, as in S402, S403, or S404 of FIG. 10, or as in S501 or S503 of FIG. 11). The processing unit 31 of the RAN node 12 may be configured to perform step S202 by executing functionality of the acquire module 31a. The computer program 42b and/or computer program product 41b may thus provide means for this step.

Examples of how the RAN node 12 may acquire the need to send RAN fallback support indication parameters will be provided below. In response to having acquired the need to send RAN fallback support indication parameters the RAN node performs step S212.

S212. The RAN node 12 sends the RAN fallback support indication parameters of the wireless device 13 to the mobility management node 11 (e.g. as in S301 or S303 of FIG. 9, as in S403 or S404 of FIG. 10, or as in S504 or S505 of FIG. 11). Particularly, this may e.g. be done by sending a message to the mobility management node 11, e.g. such as a UE Radio Capability Match Response message (e.g. as in S504 of FIG. 11) or a UE Capability Info Indication message or similar (e.g. as in S505 of FIG. 11). The processing unit 31 of the RAN node 12 may be configured to perform step S212 by executing functionality of the send and/or receive module 31b. The computer program 42b and/or computer program product 41b may thus provide means for this step.

Embodiments relating to further details of RAN fallback support indication of a wireless device 13 will now be disclosed.

Reference is now made to FIG. 8 illustrating methods for RAN fallback support indication of a wireless device 13 as performed by the RAN node 12 according to further embodiments.

Examples of how the RAN node 12 may acquire the need to send RAN fallback support indication parameters will now be disclosed.

Acquiring the need may comprise detecting a mobility event of the wireless device 13, as in step S202a.

S202a. The RAN node 12 may acquire the need to send RAN fallback support indication parameters by detecting a mobility event of the wireless device 13 (e.g. as in S301 of FIG. 9, as in S401 or S402 of FIG. 10, or as in S501 of FIG. 11). The processing unit 31 of the RAN node 12 may be configured to perform step S202a by executing functionality of the acquire module 31a. The computer program 42b and/or computer program product 41b may thus provide means for this step.

There may be different examples of detectable mobility events. For example, the mobility event may relate to a combined Attach event and/or a combined TA/LA update (e.g. as in S301 of FIG. 9). The RAN node may by itself not be able to detect what kind of mobility event has occurred.

Acquiring the need may comprise receiving a request, as in step S202b.

S202b. The RAN node 12 may acquire the need to send RAN fallback support indication parameters by receiving a request for the RAN fallback support indication parameters from the mobility management node 11 (e.g. as in S501 of FIG. 11). The processing unit 31 of the RAN node 12 may be configured to perform step S202a by executing functionality of the acquire module 31a and/or the send and/or receive module 31b. The computer program 42b and/or computer program product 41b may thus provide means for this step.

Different messages may be used to send the RAN fallback support indication parameters. For example, the RAN fallback support indication parameters may in step S212 be sent using a S1-AP message. There are different S1-AP messages that can be used for sending the RAN fallback support indication parameters For example, the S1-AP message may be a UE Radio Capability Match Response (e.g. as in S504 of FIG. 11), an UE Capability Info Indication (e.g. as in S505 of FIG. 11), an Initial UE message, or an Uplink NAS Transport message.

As disclosed above, the RAN fallback support indication parameters may comprise a list of PLMNs or similar supported by the wireless device 13, a list of RATs or similar supported by the wireless device 13, and/or a list of LAIs or similar supported by the wireless device 13. There may be different ways for the RAN node 12 to determine the list of PLMN and the list of RATs, as in step S204.

S204. The RAN node 12 may determine the list of PLMNs supported by the wireless device 13, and the list of RATs supported by the wireless device 13 by matching radio capabilities of the wireless device 13 against frequency bands of available PLMNs and RATs of a GERAN/UTRAN (e.g. as in S303 of FIG. 9, as in S404 of FIG. 10, or as in S504 of FIG. 11). The processing unit 31 of the RAN node 12 may be configured to perform step S204 by executing functionality of the determine module 31d. The computer program 42b and/or computer program product 41b may thus provide means for this step.

The RAN node 12 may, in order to match radio capabilities of the wireless device 13 against frequency bands of available PLMNs and RATs of a GERAN/UTRAN, request the wireless device 13 12 to provide its radio capabilities to the RAN node, as in step S206.

S206. The RAN node 12 may send a RRC UE Capability Enquiry message to the wireless device 13 (e.g. as in S303 of FIG. 9, as in S404 of FIG. 10, or as in S502 of FIG. 11). The processing unit 31 of the RAN node 12 may be configured to perform step S206 by executing functionality of the send and/or receive module 31b. The computer program 42b and/or computer program product 41b may thus provide means for this step.

The wireless device 13 may then inform the RAN node 12 of its radio capabilities, as in step S208.

S208. The RAN node 12 may receive a UE Capability Information message from the wireless device 13 (e.g. as in S503 of FIG. 11). The processing unit 31 of the RAN node 12 may be configured to perform step S208 by executing functionality of the send and/or receive module 31b. The computer program 42b and/or computer program product 41b may thus provide means for this step.

The RAN node 12 may then forward the information regarding the radio capabilities of the wireless device 13 to the mobility management node 11, as in step S210.

S210. The RAN node 12 may send a UE Radio Capability Match Response message to the mobility management node 11 (e.g. as in S504 of FIG. 11). The processing unit 31 of the RAN node 12 may be configured to perform step S210 by executing functionality of the send and/or receive module 31b. The computer program 42b and/or computer program product 41b may thus provide means for this step.

Hence, according to at last some of the herein disclosed embodiments, when the mobility management node 11 receives a combined Attach request or a combined TA/LA Update request from the wireless device 13, if the request is accepted and if for any available PLMN and RAT of the CS domain the mobility management node 11 has no knowledge about whether the wireless device 13 supports it, the mobility management node 11 sends a message to the RAN node 12 indicating that the RAN node 12 shall provide a list of available PLMN and RAT of the CS domain which are compatible with the radio capabilities of the wireless device 13. If the mobility management node 11 already has the valid Radio Capability information, the mobility management node 11 can include it in the message sent to the RAN node 12.

Hence, according to at last some of the herein disclosed embodiments, upon receiving the message from the mobility management node 11, for each available PLMN and RAT of the CS domain, the RAN node 12 may check whether it is supported by the wireless device 13 by comparing the frequency bands of each PLMN and RAT against the Radio Capabilities of the wireless device 13. The RAN node 12 then sends a response message to the mobility management node 11 including a list of PLMN and RAT which are supported by the wireless device 13.

Hence, according to at last some of the herein disclosed embodiments, when the mobility management node 11 receives the list of PLMNs and RATs which are supported by the wireless device 13, the mobility management node 11 stores the list of PLMNs and RATs and uses it to filter the PLMNs and RATs to be selected for the wireless device 13 if CSFB is needed.

Hence, according to at last some of the herein disclosed embodiments this enables the mobility management node to take the radio capabilities into account and only select the PLMN and RAT which is supported by the UE if the CS domain registration will be used for CS voice call when selecting the PLMN and RAT for the CS domain.

Hence, according to at last some of the herein disclosed embodiments this can be achieved by the mobility management node sending an S1-AP message to the RAN node, the mobility management node requesting CS domain parameters which can be used to determine the PLMN and RAT supported by the wireless device 13. As noted above, such parameters may be for example, a list of PLMN, a list of RATs or a list of LAIs.

Hence, according to at last some of the herein disclosed embodiments the RAN node, upon receiving the request from the mobility management node, the RAN node matches the radio capabilities of the wireless device 13 against frequency bands of available PLMN and RAT of the CS domain.

Hence, according to at last some of the herein disclosed embodiments the RAN node sends back the CS domain parameters which indicate the PLMN and RAT supported by the wireless device 13 to the mobility management node.

Hence, according to at last some of the herein disclosed embodiments the mobility management node then derives the list of PLMNs and RATs supported by the wireless device 13, stores it and uses it to select the CS domain.

Hence, according to at last some of the herein disclosed embodiments this can be achieved by the RAN node autonomously reporting to the mobility management node the relevant CS domain parameters in S1-AP messages when some mobility event is detected.

Hence, according to at last some of the herein disclosed embodiments, in addition to facilitate the PLMN and RAT selection for the CS domain during a combined Attach or a combined TA/LA Update procedure, the supported PLMN and RAT may also be used for facilitate the target cell selection during Handover from E-UTRAN to GERAN or from E-UTRAN to UTRAN. In such cases, the mobility management node may send to the RAN node the list of supported PLMN and RAT. During an inter-MME mobility procedure, the current mobility management node (such as a current MME) may send the list of supported PLMN and RAT to the target core network node (such as a target MME).

Three particular embodiments relating to RAN fallback support indication of a wireless device 13 will now be disclosed in turn. The three particular embodiments are related to different aspects of E-UTRAN, UTRAN, and GERAN, the term user equipment (UE) will be used to denote the wireless device 13, the term mobility management node (MME) will be used to denote the mobility management node, and the term evolved Node B (eNB) will be used to denote the RAN node.

The first particular embodiment relates to application of the RAN fallback support indication of the wireless device 13 to an Attach Procedure. Reference is made to the signalling diagram of FIG. 9.

The attach procedure for the CS fallback, Short Message Service (SMS) over SGs interface between the MME and the MSC or “SMS in MME” in EPS may be realized based on the combined GPRS/IMSI Attach procedure specified in TS 23.060.

S301. The UE initiates the attach procedure by transmission of an Attach Request (for example with parameters as specified in TS 23.401 including the Attach Type, old LAI and Mobile Station Classmark 2) message to the MME. The Attach Type indicates that the UE requests a combined EPS/IMSI attach and informs the network that the UE is capable and configured to use CS fallback and/or SMS over SGs. If the UE needs SMS service but not CSFB, the UE may include an “SMS-only” indication in the combined EPS/IMSI Attach Request, see for example clause 5.6 of TS 23.272.

S302. For example, step 3 to step 16 of the EPS Attach procedure may be performed for example as specified in TS 23.401 with the differences as described below when “SMS in MME” applies:

Firstly, if the MME is enabled to use “SMS in MME” and the MME is not registered with an HSS for that UE (i.e. the MME stores no subscriber data for the UE), the MME may perform a registration with the HSS, for example as described in Annex C, clause C.8 of TS 23.272.

Secondly, if the MME is enabled to use “SMS in MME” and the MME is registered with an HSS for that UE but has no valid SMS subscriber data (i.e. the MME stores subscriber data for the UE but SMS subscriber data have not been requested before or have been removed by the HSS), the MME may perform a re-registration with the HSS, for example as described in Annex C, clause C.8 of TS 23.272 to obtain SMS subscriber data and to provide the HSS with the MME identity to be used for MT-SMS delivery.

Thirdly, if the HSS supports “SMS in MME”, the HSS may follow the registration procedures described in Annex C, clause C.8 of TS 23.272.

S303. If the Attach Request message includes an Attach Type indicating that the UE requests a combined EPS/IMSI attach, the MME may allocate a new LAI for the UE, for example as described in clause 5.1A of TS 23.272.

The MME does not perform any registrations with a VLR, (i.e. it may skip steps S304 to S308 and no SGs association is created) if the Network Access Mode information in the subscriber data indicate that the subscription has no CS subscriber data; or if the HSS registered the MME for “SMS in MME” for the UE, for example as described in Annex C, clause C.8 of TS 23.272.

If the registration with a VLR is required, and if for any available PLMN and RAT for the CS domain the MME does not have any knowledge regarding whether it is supported by the UE (i.e. the UE radio capabilities match the frequency bands of this PLMN and RAT), the MME may perform a UE Radio Capability Match Request, for example as specified in TS23.401 to get the list of PLMN and RAT supported by the UE and then store the list. If the MME has the list of PLMN and RAT supported by the UE, it may use this to perform PLMN and RAT selection for the CS domain, i.e., only the PLMN and RAT supported by the UE may be selected. The UE Radio Capability Match Request is thus according to this embodiment used by the MME to obtain UE radio capabilities in the context of RAN fallback support indication, such as in order for the MME to obtain RAN fallback support indication parameters of the UE from the eNB.

S304. If the registration with a VLR is required and multiple PLMNs and RATs are available for the CS domain and supported by the UE, the MME may perform selection of the PLMN and RAT for CS domain and CS domain operator if the selected CS network has a shared network configuration, based on the PLMN ID contained in the current TAI, old LAI and operator selection policies on preferred RAT for CS domain. If the target network is a shared GERAN, the MME may also take into account the UE capability of support or non-support of GERAN network sharing when selecting the PLMN for the CS domain, for example as specified in TS 23.251. The PLMN and RAT selected for the CS domain should be the same that is used for this UE as a target PLMN and RAT for PS handovers or for any other mobility procedures related to CSFB. The MME may take any access restrictions provided by the HSS into account, if the network is using separate location areas for GERAN and UTRAN cells. The selected PLMN ID may be included in the newly allocated LAI which is sent to MSC/VLR in step S305 and in an Attach Accept message to the UE.

The MME may derive a VLR number based on the newly allocated LAI and the Temporary Mobile Subscriber Identity (TMSI) based Network Resource Identifier (NRI) as provided by the UE or on the newly allocated LAI and an IMSI hash function, for example as defined in TS 23.236. The MME starts the location update procedure towards the new MSC/VLR upon receipt of the subscriber data from the HSS in step S302. This operation marks the MS as EPS-attached in the VLR.

S305. The MME sends a Location Update Request (new LAI, IMSI, MME name, Location Update Type, selected CS domain operator) message to the MSC/VLR 24. The MME name may be a Fully Qualified Domain Name (FQDN) string. Cases in which the MME includes the selected CS domain operator towards the VLR are specified in TS 23.251.

Furthermore, in this example the MME 11 sends the RAN fallback support indication parameters of the wireless device 13 to the MSC/VLR 24. Alternatively, the MME 11 may e.g. send the RAN fallback support indication parameters of the wireless device 13 to the RAN node 12b of FIG. 1a (not shown in FIG. 9) acting as a target RAN node.

S306. The VLR creates an association with the MME by storing the MME name.

S307. The VLR performs normal subscription checks for the CS domain and if all checks are successful the VLR performs Location Updating procedure in the CS domain.

For Gateway Core Network (GWCN) configuration, the MSC selects a core network operator, for example as specified in TS 23.251.

S308. The VLR responds with a Location Update Accept (VLR TMSI) to the MME.

S309. The EPS Attach procedure is completed, for example by performing step 17 to step 26 as specified in TS 23.401. The Attach Accept message may include the parameters as specified in TS 23.401, such as: VLR TMSI and LAI as allocated in step S303 above. The existence of LAI and VLR TMSI indicates successful attach to the CS domain.

If the UE requests a combined EPS/IMSI Attach Request without the “SMS-only” indication, and if the network supports SGs procedures only for SMS or the network decided to provide “SMS in MME” for the UE, the MME may indicate in the Attach Accept message that the IMSI attach is for “SMS-only”. When the network accepts a combined EPS/IMSI attach without limiting to “SMS-only”, the network may provide a “CSFB Not Preferred” indication to the UE.

If the UE requests a combined EPS/IMSI Attach Request with the “SMS-only” indication, and if the network supports SGs procedures only for SMS or if it supports CSFB and SMS over SGs or the network decided to provide “SMS in MME” for the UE, the MME may indicate in the Attach Accept message that the IMSI attach is for “SMS-only”.

If the MME provides “SMS in MME” for the UE, then the TMSI and LAI may be provided for example as specified in clause C.4.2 of TS 23.272.

The network provides the “SMS-only” or “CSFB Not Preferred” indications based on locally configured operator policies based on e.g. a roaming agreement.

The UE behaviour upon receiving such indications may follow what is described in TS 23.221.

If the PLMN ID for the CS domain (included in the LAI provided to the UE) differs from the PLMN ID provided as part of the Globally Unique Temporary Identifier (GUTI), the equivalent PLMNs list includes the PLMN ID for the CS domain.

S310. If the VLR has updated the SGs association and if a paging timer is still running for a MT service for this UE, the VLR may repeat SGs Paging Request towards the updated SGs association.

The case of unsuccessful attach to the CS domain is documented in stage 3 specifications, taking into account reachability for CS services of UEs that have the user preference to prioritize voice over data services and are not configured/supporting to use IMS voice services.

The second particular embodiment relates to application of the RAN fallback support indication of the wireless device 13 to a combined TA/LA Update Procedure. Reference is made to the signalling diagram of FIG. 10.

The combined TA/LA Update procedure for the CS fallback, SMS over SGs or “SMS in MME” in EPS may be realized based on the combined RA/LA Update procedure specified in TS 23.060.

S401. The UE detects a change to a new TA by discovering that its current TAI is not in the list of TAIs that the UE registered with the network or the UE's TIN indicates the need for a TAU when re-selecting to E-UTRAN. The combined TA/LA Update Procedure is also performed in order to re-establish the SGs association.

S402. The UE initiates the TAU procedure, for example by sending a TAU Request (for example with parameters as specified in TS 23.401, such as the Update Type, old LAI and Mobile Station Classmark 2) message to the MME. The Update Type indicates that this is a combined Tracking Area/Location Area Update Request or a combined Tracking Area/Location Area Update with IMSI attach Request. If the UE needs SMS service but not CSFB, the UE may include an “SMS-only” indication in the combined TA/LA Update procedure, for example as in clause 5.6 of TS 23.272.

S403. Step 4 to step 19 of the EPS TAU procedure may be performed as specified in TS 23.401 with the differences as described below when “SMS in MME” applies:

Firstly, if the MME is enabled to use “SMS in MME” and the MME is not registered with an HSS for that UE (i.e. the MME does not store any subscriber data for the UE), the MME may perform a registration with the HSS, for example as described in Annex C, clause C.8 of TS 23.272.

Secondly, if the MME is enabled to use “SMS in MME” and the MME is registered with an HSS for that UE but does not have any valid SMS subscriber data (i.e. the MME stores subscriber data for the UE but SMS subscriber data have not been requested before or have been removed by the HSS), the MME may perform a re-registration with HSS, for example as described in Annex C, clause C.8 of TS 23.272 to obtain SMS subscriber data and to provide the HSS with the MME identity to be used for MT-SMS delivery.

Thirdly, if the HSS supports “SMS in MME” the HSS may follow the registration procedures described in Annex C, clause C.8 of TS 23.272.

The MME may not perform any registrations with a VLR, (i.e. it may skip steps S404 to S407 and no SGs association may be created) if the Network Access Mode information in the subscriber data indicate that the subscription has no CS subscriber data or if the HSS registered the MME for “SMS in MME” for the UE, for example as described in Annex C, clause C.8 of TS 23.272.

S404. If registration with a VLR is required, and if for any available PLMNs and RATs for the CS domain the MME has no knowledge about whether it is supported by the UE (i.e. the UE radio capabilities match the frequency bands of this PLMN and RAT), the MME may perform UE Radio Capability Match Request, for example as specified in TS23.401, to obtain the list of PLMNs and RATs supported by the UE and then store the list. If the MME has the list of PLMNs and RATs supported by the UE, it may use this to perform PLMN and RAT selection for the CS domain, i.e. only the PLMN and RAT supported by the UE may be selected.

S405. If multiple PLMNs and RATs are available for the CS domain and are supported by the UE, the MME may perform selection of the PLMN and RAT for the CS domain and the CS domain operator if the selected CS network has a shared network configuration, for example based on current TAI, old LAI and operator selection policies on a preferred RAT for the CS domain. If the target network is a shared GERAN, the MME may also take into account the UE capability of support or non-support of GERAN network sharing when selecting the PLMN for the CS domain, for example as specified in TS 23.251. The PLMN and RAT selected for the CS domain should be the same as is used for this UE as a target PLMN and RAT for PS handovers or for any other mobility procedures related to CSFB. The MME may take any access restrictions provided by the HSS into account if the network is using separate location areas for GERAN and UTRAN cells. The selected PLMN ID may be included in the newly allocated LAI. If the association has to be established or if the LA changed, the new MME may send a Location Update Request (new LAI, IMSI, MME name, Location Update Type, selected CS domain operator) message to the VLR. The cases in which the MME includes the selected CS domain operator towards the VLR may be those as specified in TS 23.251. The MME retrieves the corresponding VLR number from the determined LM. If multiple MSC/VLRs serve this LAI, the TMSI based NRI as provided by the UE or an IMSI hash function may be used to retrieve the VLR number for the LM, for example as defined in TS 23.236. The Location Update Type may indicate normal location update. The MME name may be a FQDN string.

S406. The VLR performs normal subscription checks for the CS domain and if all checks are successful the VLR may perform a Location Update procedure in the CS domain.

For GWCN configuration, the MSC may select the core network operator, for example as specified in TS 23.251.

S407. The VLR responds with a Location Update Accept (VLR TMSI) to the MME.

S408. The MME sends a TAU Accept (for example with parameters as specified in TS 23.401, LAI, VLR TMSI) message to the UE. The VLR TMSI is optional if the VLR has not changed. LAI is determined in step S405 above. The presence of the LAI indicates to the UE that it is IMSI attached. If the UE requests combined TA/LA Update Request without the “SMS-only” indication, and if the network supports SGs for SMS only, the network may perform the IMSI attach and the MME may indicate in the TAU Accept message that the IMSI attach is for “SMS-only”.

If the UE requests a combined TA/LA Update (or a combined TA/LA Update with IMSI attach) without the “SMS-only” indication, and if the network supports SGs procedures only for SMS or the network decided to provide “SMS in MME” for the UE, the MME may indicate “SMS-only” in the TAU Accept message. However, if the network supports CSFB and SMS over SGs and accepts a combined TA/LA Update procedure but does not indicate “SMS-only”, the MME may provide a “CSFB Not Preferred” indication to the UE.

If the UE requests combined TA/LA Update (or combined TA/LA Update with IMSI attach) with the “SMS-only” indication, and if the network only supports SGs procedures for SMS or if it supports CSFB and SMS over SGs or if the network decided to provide “SMS in MME” for the UE, the MME may indicate in the TAU Accept message that the combined TA/LA Update procedure is for “SMS-only”.

If the MME provides “SMS in MME” for the UE, then the TMSI and LAI may be provided for example as specified in clause C.4.2 of TS 23.272.

The network may provides the “SMS-only” or “CSFB Not Preferred” indications based on locally configured operator policies based on e.g. roaming agreements.

The UE behaviour upon receiving such indications is for example described in TS 23.221.

If the PLMN ID for the CS domain (included in the LAI provided to the UE) differs from the PLMN ID provided as part of the GUTI, the equivalent PLMNs list may include the PLMN ID for the CS domain.

S409. The UE may send a TAU complete message, for example as specified in TS 23.401 for the TAU procedure.

S410. If the VLR has updated the SGs association and if a paging timer is still running for a MT service for this UE, the VLR may repeat SGs Paging Request towards the updated SGs association.

The third particular embodiment relates to application of the RAN fallback support indication of the wireless device 13 to a UE Radio Capability Match Request. Reference is made to the signalling diagram of FIG. 11.

If the MME requires more information on the UE radio capabilities support to be able to set the IMS voice over PS Session Supported Indication (see clause 4.3.5.8 of TS 23.272) or requires more information relating to the UE radio capabilities support of each available PLMN and RAT of the CS domain, then the MME may send a UE Radio Capability Match Request message to the eNB according to this embodiment. This procedure is typically used during the Initial Attach procedure, during Tracking Area Update procedure for the “first TAU following GERAN/UTRAN Attach” or for “UE radio capability update” or when the MME has not received the Voice Support Match Indicator (as part of the MM Context). This procedure is also used during the combined Attach procedure or the combined TA/LA update procedure when the MME does not have any knowledge about the UE radio capabilities support of any available PLMN or RAT of the CS domain.

S501. The MME sends an S1-AP message, e.g. a UE Radio Capability Match Request (CS domain indicator) to the eNB, thereby indicating that a list of available PLMN and RAT or similar of the CS domain supported by the UE shall be provided. The MME may include the UE Radio Capability information that previously may have received from the eNB via a S1-AP UE CAPABILITY INFO INDICATION, for example as described in clause 5.11.2 of TS 23.272. The MME may indicate whether the MME wants to receive a Voice support match indicator or the list of supported PLMN sand RATs of the CS domain for the UE.

S502. Upon receiving a UE Radio Capability Match Request (i.e., a CS domain indicator) from the MME, if the eNB has not already received the UE radio capabilities from the UE or from MME in step S501, the eNB requests the UE to upload the UE Radio Capability information by sending a RRC UE Capability Enquiry.

S503. The UE provides the eNB with its UE radio capabilities by sending the RRC UE Capability Information.

S504. The eNB checks whether the UE radio capabilities are compatible with the frequency bands of each available PLMN and RAT or similar of the CS domain. If the Voice support match indicator is requested by the MME, the eNB checks whether the UE radio capabilities are compatible with the network configuration for ensuring voice service continuity of voice calls initiated in IMS; if the list of supported PLMNs and RATs of the CS domain is requested by the MME, the eNB checks whether the UE radio capabilities are compatible with frequency bands of each available PLMN and RAT of the CS domain.

The eNB sends a UE Radio Capability Match Response to the MME. The message comprises a list of CS domain PLMNs and RATs which are supported by the UE. The MME stores the list of CS domain PLMNs and RATs. The stored list may be considered as valid as long as the UE Radio Capability information is considered as valid. Refer to TS 23.401 for more details. For determining the appropriate UE Radio Capability Match Response for Voice support match indicator, the eNB is configured by the operator to check whether the UE supports certain capabilities required for Voice continuity of voice calls using IMS PS. In a shared network, the eNB keeps a configuration separately per PLMN.

What checks to perform generally depends on the network configuration. Some examples of UE capabilities to be taken into account are: the SRVCC, and UTRAN/E-UTRAN Voice over PS capabilities; the Radio capabilities for UTRAN/E-UTRAN FDD and/or TDD; and/or the support of UTRAN/E-UTRAN frequency bands.

The network configuration considered in the decision for the Voice Support Match Indicator is homogenous within a certain area (e.g. a MME Pool Area) in order to guarantee that the Voice Support Match Indicator from the eNB is valid within such an area.

The eNB may provide a Voice Support Match Indicator to the MME to indicate whether the UE capabilities and networks configuration are compatible for ensuring voice service continuity of voice calls initiated in IMS.

The eNB may provide to the MME the list of PLMNs and RATs of the CS domain which match UE radio capabilities.

The MME may store the received Voice support match indicator in the MM Context and use it as an input for setting the IMS voice over PS Session Supported Indication.

When the MME selects the PLMN and RAT of the CS domain for the UE, it may also take the UE radio capabilities into account, i.e. only the PLMNs and RATs that are supported by UE may be selected if the CS registration will be used for CS voice call. The MME may store the list of PLMN sand RATs of the CS domain and use it as an input for PLMN and RAT selection of the CS domain.

S505. If the eNB requested radio capabilities from the UE in step S502 and/or S503, the eNB also sends the UE radio capabilities to the MME preferably using the S1-AP UE CAPABILITY INFO INDICATION. The MME may store the UE radio capabilities without interpreting them for further provision to the eNB, for example in cases described in clause 5.11.2 of TS 23.272.

Steps S404 and S505 may be received by the MME in any order.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for radio access network, RAN, fallback support indication of a wireless device, the method being performed by a mobility management node, comprising the steps of:
receiving RAN fallback support indication parameters of the wireless device from a RAN node; and
sending the RAN fallback support indication parameters of the wireless device to at least one of a target core network node of the wireless device, a target RAN node of the wireless device.

2. The method according to claim 1, wherein the RAN fallback support indication is a fallback support indication of the wireless device from E-UTRAN to at least one of GERAN and UTRAN.

3. The method according to claim 1, further comprising:
detecting a mobility event of the wireless device; and in response thereto:
sending a request for the RAN fallback support indication parameters to the RAN node.

4. The method according to claim 3, wherein the request is sent using a S1-AP message.

5. The method according to claim 4, wherein the S1-AP message is a UE Radio Capability Match Request message.

6. The method according to claim 3, wherein the mobility event relates to at least one of a combined Attach event and a combined TA/LA update.

7. The method according to claim 3, wherein detecting the mobility event of the wireless device further comprises:
receiving a UE Radio Capability Match Response message from the RAN node.

8. The method according to claim 1, further comprising:
determining at least one of a PLMN and a RAT supported by the wireless device from the RAN fallback support indication parameters.

9. The method according to claim 1, wherein the RAN fallback support indication parameters comprises at least one of a list of PLMNs supported by the wireless device, a list of RATs supported by the wireless device, and a list of LAIs supported by the wireless device.

10. The method according to claim 9, further comprising:
sending at least one of the list of PLMNs supported by the wireless device and the list of RATs supported by the wireless device to at least one of the target core network node of the wireless device and the target RAN node of the wireless device.

11. The method according to claim 10, wherein the at least one the list of PLMNs supported by the wireless device and the list of RATs supported by the wireless device is sent using a S1-AP message or a GTPv2 message.

12. The method according to claim 11, wherein the S1-AP message is one from an Initial UE Context Setup message, a Path Switch Acknowledge message, and a Handover Request message, and wherein the GTPv2 message is one from a Context Response message and a Forward Relocation Request message.

13. The method according to claim 1, further comprising:
storing the RAN fallback support indication parameters.

14. The method according to claim 13, wherein the RAN fallback support indication parameters are stored at least until a further mobility event of the wireless device is detected.

15. A method for radio access network, RAN, fallback support indication of a wireless device, the method being performed by a RAN node, comprising the steps of:
acquiring a need to send RAN fallback support indication parameters of a wireless device to a mobility management node; and in response thereto:
sending the RAN fallback support indication parameters of the wireless device to the mobility management node.

16. The method according to claim 15, wherein acquiring said need comprises:
detecting a mobility event of the wireless device.

17. The method according to claim 16, wherein the mobility event relates to at least one of a combined Attach event and a combined TA/LA update.

18. The method according to claim 15, wherein acquiring said need comprises:
receiving a request for the RAN fallback support indication parameters from the mobility management node.

19. The method according to claim 15, wherein the RAN fallback support indication parameters are sent using a S1-AP message.

20. The method according to claim 19, wherein the S1-AP message is one from a UE Radio Capability Match Response, an Initial UE message, and an Uplink NAS Transport message.

21. The method according to claim 15, wherein the RAN fallback support indication parameters comprises at least one of a list of PLMNs supported by the wireless device, a list of RATs supported by the wireless device, and a list of LAIs supported by the wireless device.

22. The method according to claim 21, further comprising:
determining the list of PLMNs supported by the wireless device, and the list of RATs supported by the wireless device by matching radio capabilities of the wireless device against frequency bands of available PLMNs and RATs of a GERAN/UTRAN.

23. The method according to claim 22, further comprising:
sending a RRC UE Capability Enquiry message to the wireless device.

24. The method according to claim 23, further comprising:
receiving a UE Capability Information message from the wireless device.

25. The method according to claim 24, further comprising:
sending a UE Radio Capability Match Response message to the mobility management node.

26. A mobility management node for radio access network, RAN, fallback support indication of a wireless device, the mobility management node comprising a processing unit configured to:
receive RAN fallback support indication parameters of the wireless device from a RAN node; and
send the RAN fallback support indication parameters of the wireless device to at least one of a target core network node of the wireless device and a target RAN node of the wireless device.

27. A radio access network, RAN, node for RAN fallback support indication of a wireless device, the RAN node comprising a processing unit configured to:
acquire a need to send RAN fallback support indication parameters of a wireless device to a mobility management node; and in response thereto:
send the RAN fallback support indication parameters of the wireless device to the mobility management node.

28. (canceled)
